(19) United States
(12) Patent Application Publication
(10) Pub. No.: US 2016/0379381 A1
(43) Pub. Date: Dec. 29, 2016

(54) APPARATUS AND METHOD FOR VERIFYING THE ORIGIN OF TEXTURE MAP IN GRAPHICS PIPELINE PROCESSING

(71) Applicant: FREESCALE SEMICONDUCTOR, INC., Austin, TX (US)

(72) Inventors: ROBERT CRISTIAN KRUTSCH, MUNICH (DE); OLIVER BIBEL, GRASBRUNN (DE); ROLF DIETER SCHLAGENHAFT, POING (DE)

(21) Appl. No.: 14/747,023

(22) Filed: Jun. 23, 2015

(51) Int. Cl. G06T 11/00; G06T 1/20; G06K 9/62; G06K 9/46; G06T 15/80; G06T 15/40

(52) U.S. Cl. CPC G06T 11/001; G06T 15/80; G06T 15/405; G06K 9/6202; G06K 9/4604; G06T 1/20

(57) ABSTRACT

The present application relates to an apparatus for verifying the origin of texture data and a method of operating thereof. The apparatus comprises a frame buffer; at least one texture buffer; a graphics processing pipeline with a fragment shader unit; and a comparator unit. The at least one texture buffer is provided to store texture data and test texture data. The fragment shader unit maps the test texture data retrieved from the texture buffer on a predefined area of the image data stored in the frame buffer. The comparator unit extracts image data values located in the predefined area of the image data stored in the frame buffer; compares the extracted image data with reference data and issues a fault indication signal in case the extracted image data and the reference data mismatch.

### FIELD OF THE INVENTION

The present invention relates generally to the field of graphics processing and more specifically to an apparatus and method for verifying the origin of GPU mapped texture data.

### BACKGROUND

A typical computing system includes a central processing unit (CPU) and a graphics processing unit (GPU). Some GPUs are capable of very high performance using a relatively large number of small, parallel execution threads on dedicated programmable hardware processing units. The specialized design of such GPUs usually allows these GPUs to perform certain tasks, such as rendering 3-D scenes, much faster than a CPU. However, the specialized design of these GPUs also limits the types of tasks that the GPU can perform. The CPU is typically a more general-purpose processing unit and therefore can perform most tasks. Consequently, the CPU usually executes the overall structure of the software application and configures the GPU to perform specific tasks in the graphics pipeline (the collection of processing steps performed to transform 3-D images into 2-D images).

Such graphics processing units (GPUs) are performance optimized but lack fault detection and handling required for functional safety. Functional safety is a primary issue when displaying safety relevant information to a user. Safety relevant or safety related information represents information, an erroneous content of which might be directly responsible for death, injury or occupational illness, or the erroneous content of which may be the basis for decisions relied on, which might cause death, injury, other significant harms or other significant actions. Safety relevant or safety related information may be the output of safety critical application typically operated in a safety critical environment, which is one in which a computer software activity (process, functions, etc.) whose errors, such as inadvertent or unauthorized occurrences, failure to occur when required, erroneous values, or undetected hardware failures can result in a potential hazard, or loss of predictability of system outcome.

The lack of fault detection and handling required for functional safety in prior art graphics processing units (GPUs) may result in an unnoticed displaying of an erroneous or incomplete image, for example due to a fault in the hardware or software, which may result in a dangerous action for a user relying on the information conveyed by the wrong image.

Accordingly, what is needed in the art is a fault detection and handling required for functional safety for graphics processing units (GPUs) processing graphical content including safety relevant information to be presented to a user.

### SUMMARY

The present invention provides an apparatus for verifying the origin of texture data, a method of operating thereof and a non-transitory, tangible computer readable storage medium bearing computer executable instructions for verifying the origin of texture data as described in the accompanying claims. Specific embodiments of the invention are set forth in the dependent claims. These and other aspects of the invention will be apparent from and elucidated with reference to the embodiments described hereinafter.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

FIG. 1 schematically illustrates a diagram of a surround view system according to an example of the present invention;

FIG. 2 schematically illustrates a block diagram of a computing system with a graphics processing subsystem according to an example of the present invention;

FIG. 3 schematically illustrates a block diagram of a graphics processing pipeline executed at the graphics processing subsystem as shown in FIG. 2 according to an example of the present invention;

FIG. 4 schematically illustrates a further block diagram of a graphics processing pipeline executed at the graphics processing subsystem as shown in FIG. 2 according to an example of the present invention;

FIG. 5 schematically illustrates a block diagram of a comparator unit according to an example of the present invention showing the flow of data;

FIG. 6 schematically illustrates a flow diagram relating to the functionality of the comparator unit of FIG. 4 according to an example of the present invention; and

FIG. 6 schematically illustrates a graphics primitive applied to map test texture pattern to an image in a frame buffer for being detected by the comparator unit of FIG. 4 according to an example of the present invention.

### DETAILED DESCRIPTION

Embodiments of the present disclosure will be described below in detail with reference to drawings. Note that the same reference numerals are used to represent identical or equivalent elements in figures, and the description thereof will not be repeated. The embodiments set forth below represent the necessary information to enable those skilled in the art to practice the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

In today's car instrument panels integrate information originating from various sources in from of graphical representations on one or more displays. Typical sources generating graphical representations may be classified in safety relevant sources and non-safety relevant sources. Safety relevant sources are sources, which generate graphical representations to be displayed to a user of the car, which convey safety relevant information to the car's user.

Safety relevant information generated by safety relevant sources may comprises information relating to, for example, the current velocity of the car, head lamp control, engine temperature, ambient environment, condition and status of a brake system including e.g. an anti-lock braking system (ABS) or an electronic brake-force distribution system (EBD), condition and status of an electrical steering system including e.g. an electronic stability control system (ESC), a traction control system (TCS) or anti-slip regulation system (ASR), or indications and status of advanced driver assistance systems (ADAS) including e.g. an adaptive cruise control (ACC) system, a forward collision warning (FCW) system, a lane departure warning (LDW) system, a blind spot monitoring (BSM) system, a traffic sign recognition (TSR) system, just to name a few.

Non-safety relevant information generated by non-safety relevant sources may comprises information relating to, for example, a navigation system, a multimedia system, and comfort equipment such as automatic climate control, just to name a few.

The information generated by safety and non-safety relevant sources are composed and presented in form of graphical representations on the one or more displays of the car. It is immediately understood that fault detection and handling required for functional safety have to be implemented allow detecting whether at least the graphical representations conveying safety relevant information are displayed completely and unaltered to the user of the car such. In particular, graphics processing units (GPU), which allow to efficiently generate complex graphical representations on displays, represent a major challenge for implementing fault detection and handling required for functional safety.

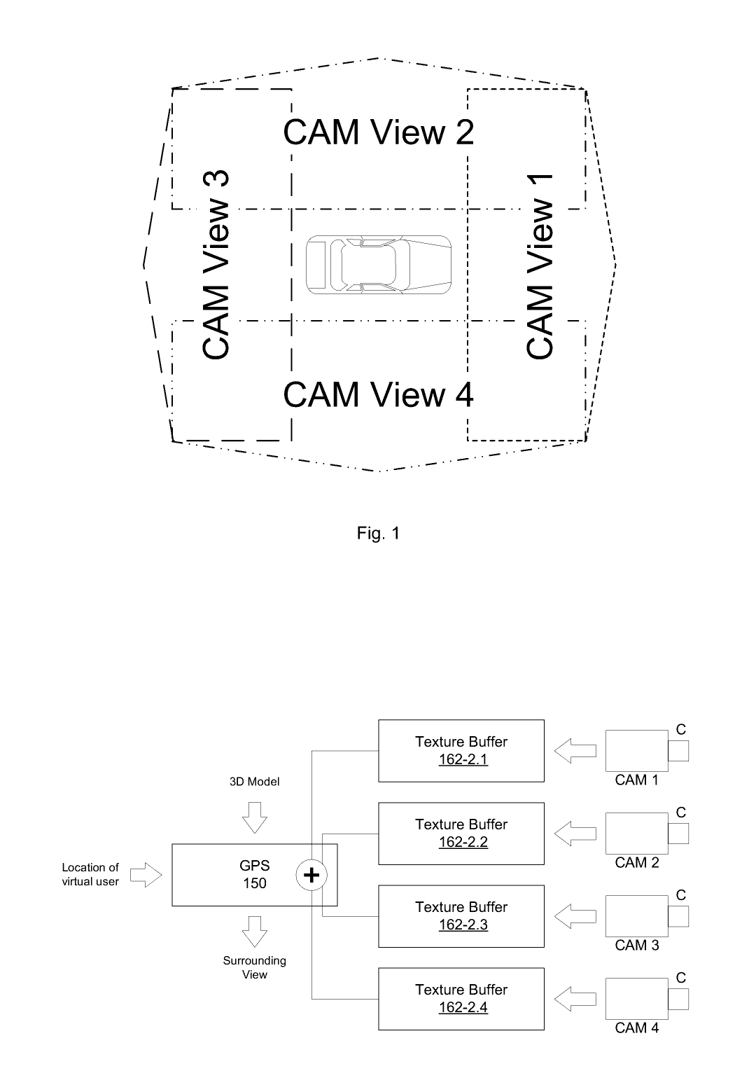

Referring now to FIG. 1, a vehicle 10 is schematically shown, in which cameras, e.g. four fish-eye cameras, are incorporated to generate a surround view. The image sensors or cameras are placed in the perimeter of the vehicle in such a way that they cover the complete surrounding perimeter. In particular, the image sensors or cameras are placed symmetrically in the perimeter of the vehicle. By way of example, the side cameras may be provided in the left and right door mirrors to take the cam view 2 and cam view 4. The rear and the front cameras may be located in different locations depending on the type of the vehicle to take the cam view 1 and cam view 3. The vehicle surround view system furthermore comprises an image processing unit that receives the image data generated by the different cameras and which fuses the image data in such a way that a surround view is generated. More specifically, the cameras can have fish-eye lenses, which are wide-angle lenses. The image processing unit combines the different images in such a way that a surround view image is generated that can be displayed on a display. With the surround view system a view can be generated of the vehicle surroundings corresponding to a virtual user located somewhere in the vehicle surroundings. By way of example, one possible position of the virtual user is above the vehicle to generate a bird's eye view, in which the vehicle surroundings are seen from above the vehicle.

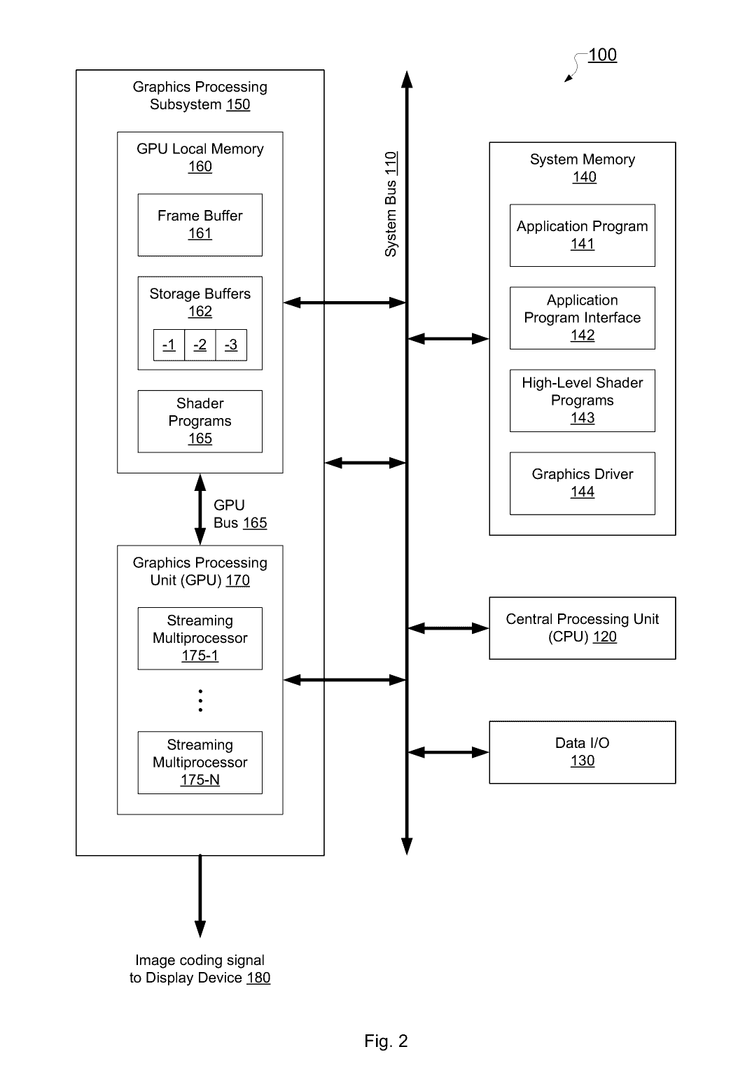

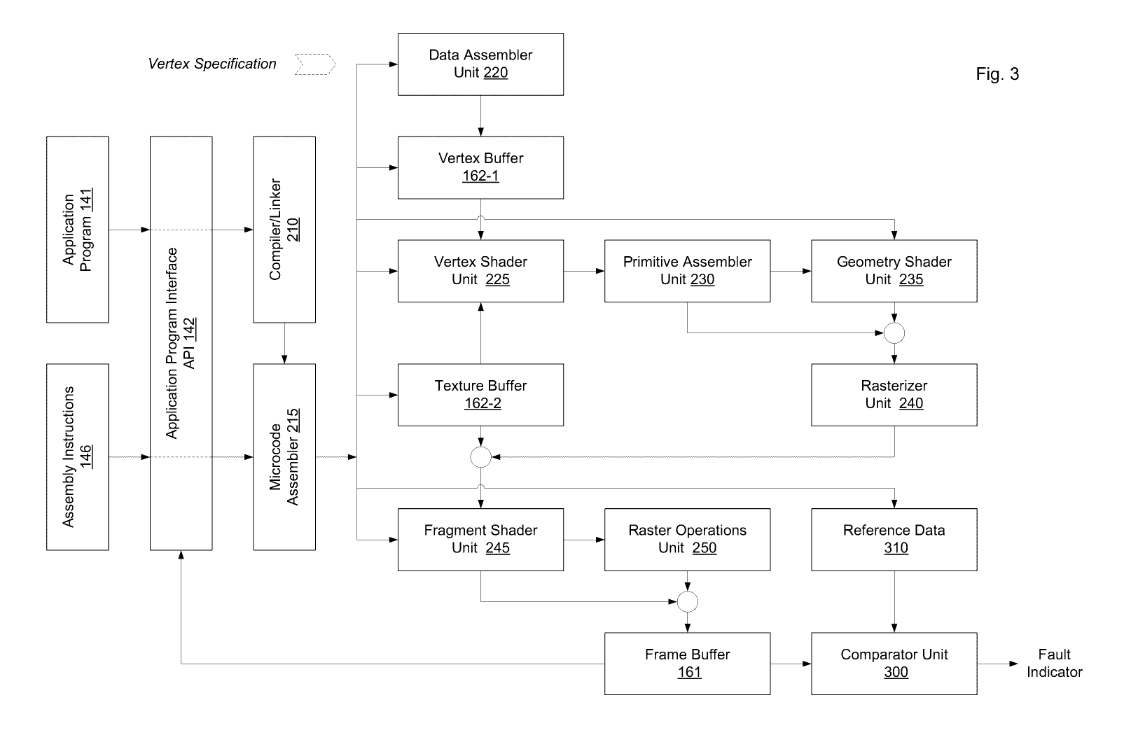

To generate views of the vehicle surroundings corresponding to various virtual users located somewhere in the vehicle surroundings, the image data generated by the different cameras may be provided as texture data each in a separate texture buffer 162-2.1 to 162-2.4 to be retrieved therefrom to be mapped onto surfaces of a three-dimensional model of the perimeter of the vehicle using a graphics processing system 150 with a graphics processing pipeline as exemplified below in detail with reference to FIGS. 2 and 3. Starting from the three-dimensional model, the views of the vehicle surroundings corresponding to various virtual users located somewhere in the vehicle surroundings can be rendered. The image data generated by the different cameras should be considered as safety relevant information. The surround view generated from image data generated by the different cameras may be used by a driver to maneuver a car in an environment with passing cars and persons.

Those skilled on the art understand from the above exemplified surrounding view application that there is a need to enable verification of the origin of texture data, or the source texture buffer, in an image generated by a graphics processing system. As understood more fully from the following description, there is a need to enable verification of the texture buffer, from which texture data is retrieved to be mapped onto a surface of an object of the model, on the basis of which the graphics processing system generates an image to be displayed. Such a verification allows for texture data used by the graphics processing pipeline is retrieved from the intended source texture buffer.

It should be noted that, although the following description exemplifies the displaying of safety relevant information in the context of an automotive use case, those skilled in the art will appreciate that the present application is not limited thereto. Rather, the present application is applicable to various use cases such as in the field of transportation including automotive, aviation, railway and space but also in industrial automation and medical equipment just to mention a few of use fields.

FIG. 2 shows is a schematic block diagram of a computing system 100 with a programmable graphics processing subsystem 150 according to an example of the present application. As shown, the computing system 100 includes a system data bus 110, a central processing unit (CPU) 120, one or more data input/output units 130, a system memory 140, and a graphics processing subsystem 150, which is coupled to a one or more display devices 180. In further examples, the CPU 120, at least portions of the graphics processing subsystem 150, the system data bus 110, or any combination thereof, may be integrated into a single processing unit. Further, the functionality of the graphics processing subsystem 150 may be included in a chipset or in some other type of special purpose processing unit or co-processor.

The system data bus 110 interconnects the CPU 120, the one or more data input/output units 130, the system memory 140, and the graphics processing subsystem 150. In further examples, the system memory 140 may connect directly to the CPU 120. The CPU 120 receives user input and/or signals from one or more the data input/output units 130, executes programming instructions stored in the system memory 140, operates on data stored in the system memory 140, and configures the graphics processing subsystem 150 to perform specific tasks in the graphics pipeline. For example, the CPU 120 may read a rendering method and corresponding textures a data storage, and configure the graphics processing subsystem 150 to implement this rendering method. The system memory 140 typically includes dynamic random access memory (DRAM) used to store programming instructions and data for processing by the CPU 120 and the graphics processing subsystem 150. The graphics processing subsystem 150 receives instructions transmitted by the CPU 120 and processes the instructions in order to render and display graphics images on the one or more display devices 180.

The system memory 140 includes an application program 141, an application programming interface (API) 142, high-level shader programs 143, and a graphics processing unit (GPU) driver 144. The application program 141 generates calls to the API 142 in order to produce a desired set of results, typically in the form of a sequence of graphics images. The application program 141 also transmits one or more high-level shading programs 143 to the API 142 for processing within the GPU driver 144. The high-level shading programs 143 are typically source code text of high-level programming instructions that are designed to operate on one or more shaders within the graphics processing subsystem 150. The API 142 functionality is typically implemented within the GPU driver 144. The GPU driver 144 is configured to translate the high-level shading programs 143 into machine code shading programs that are typically optimized for a specific type of shader (e.g., vertex, geometry, or fragment) of the graphics pipeline.

The graphics processing subsystem 150 includes a graphics processing unit (GPU) 170, a GPU local memory 160, and a GPU data bus 165. The GPU 170 is configured to communicate with the GPU local memory 160 via the GPU data bus 165. The GPU 170 may receive instructions transmitted by the CPU 120, process the instructions in order to render graphics data and images, and store these images in the GPU local memory 160. Subsequently, the GPU 170 may display certain graphics images stored in the GPU local memory 160 on the one or more display devices 180.

The GPU 170 includes one or more streaming multiprocessors 175-1 to 175-N. Each of the streaming multiprocessors 175 is capable of executing a relatively large number of threads concurrently. Particularly, each of the streaming multiprocessors 175 can be programmed to execute processing tasks relating to a wide variety of applications, including but not limited to linear and nonlinear data transforms, filtering of video and/or audio data, modeling operations (e.g. applying of physics to determine position, velocity, and other attributes of objects), and so on. Furthermore, each of the streaming multiprocessors 175 may be configured as one or more programmable shaders (e.g., vertex, geometry, or fragment) each executing a machine code shading program (i.e., a thread) to perform image rendering operations. The GPU 170 may be provided with any amount GPU local memory 160, including none, and may use GPU local memory 160 and system memory 140 in any combination for memory operations.

The GPU local memory 160 is configured to include machine code shader programs 165, one or more storage buffers 162, and a frame buffer 161. The machine code shader programs 165 may be transmitted from the GPU driver 144 to the GPU local memory 160 via the system data bus 110. The machine code shader programs 165 may include a machine code vertex shading program, a machine code geometry shading program, a machine code fragment shading program, or any number of variations of each. The storage buffers 162 are typically used to store shading data, generated and/or used by the shading engines in the graphics pipeline. E.g. the storage buffers 162 may comprise one or more vertex data buffers 162-1, one or more a texture buffer 162-2 and/or one or more feedback buffers 162-3. The frame buffer 161 stores data for at least one two-dimensional surface that may be used to drive the display devices 180. Furthermore, the frame buffer 161 may include more than one two-dimensional surface. For instance the GPU 170 may be configured to render one two-dimensional surface while a second two-dimensional surface is used to drive the display devices 180.

The display devices 180 are one or more output devices capable of emitting a visual image corresponding to an input data signal. For example, a display device may be built using a cathode ray tube (CRT) monitor, a liquid crystal display, an image projector, or any other suitable image display system. The input data signals to the display devices 180 are typically generated by scanning out the contents of one or more frames of image data that is stored in the frame buffer 161.

It should be noted that the memory of the graphics processing subsystem 150 is any memory used to store graphics data or program instructions to be executed by programmable graphics processor unit 170. The graphics memory may include portions of system memory 140, the local memory 160 directly coupled to programmable graphics processor unit 170, storage resources coupled to the streaming multiprocessors 175 within programmable graphics processor unit 170, and the like. Storage resources can include register files, caches, FIFOs (first in first out memories), and the like.

FIG. 3 shows a schematic block diagram of a programmable graphics pipeline 200 implementable within the GPU 170 of the graphics processing subsystem 150 exemplified in FIG. 2, according to one example of the application.

As shown, the shader programming model 200 includes the application program 141, which transmits high-level shader programs to the graphics driver 144. The graphics driver 144 then generates machine code programs that are used within the graphics processing subsystem 150 to specify shader behavior within the different processing domains of the graphics processing subsystem 150.

The high-level shader programs transmitted by the application program 141 may include at least one of a high-level vertex shader program, a high-level geometry shader program and a high-level fragment shader program. Each of the high-level shader programs is transmitted through an API 142 to a compiler/linker 210 within the GPU driver 144. The compiler/linker 210 compiles the high-level shader programs 143 into assembly language program objects. Under shader programming model, domain-specific shader programs, such as high-level vertex shader program, high-level geometry shader program, and high-level fragment shader program, are compiled using a common instruction set target, supported by an instruction set library. With the instruction set, application developers can compile high-level shader programs in different domains using a core set of instructions. For example, compiler/linker 210 translates the high-level shader programs designated for different domains (e.g., the high-level vertex shader program, the high-level geometry shader program, and the high-level fragment shader program), which are written in high-level shading language, into distinct compiled software objects in the form of assembly code.

The program objects are transmitted to the microcode assembler 215, which generates machine code programs, including a machine code vertex shader program, a machine code geometry shader program and a machine code fragment shader program. The machine code vertex shader program is transmitted to a vertex processing unit 225 for execution. Similarly, the machine code geometry shader program is transmitted to a primitive processing/geometry shader unit 235 for execution and the machine code fragment shader program is transmitted to a fragment processing unit 245 for execution.

The compiler/linker 210 and the microcode assembler 215 form the hardware related driver layer of the graphics driver 144, which interfaces with the application program 141 through the application program interface, API, 142.

In an example of the present application, shader programs may be also transmitted by the application program 141 via assembly instructions 146. The assembly instructions 146 are transmitted directly to the GPU microcode assembler 215 which then generates machine code programs, including a machine code vertex shader program, a machine code geometry shader program and a machine code fragment shader program.

A data assembler 220 and the vertex shader unit 225 interoperate to process a vertex stream. The data assembler 220 is a fixed-function unit that collects vertex data for high-order surfaces, primitives, and the like, and outputs the vertex data to vertex shader unit 225. The data assembler 260 may gather data from buffers stored within system memory 140 and GPU local memory 160, such as the vertex buffer 162-1, as well as from API calls from the application program 141 used to specify vertex attributes. The vertex shader unit 225 is a programmable execution unit that is configured to execute a machine code vertex shader program, transforming vertex data as specified by the vertex shader programs. For example, vertex shader unit 225 may be programmed to transform the vertex data from an object-based coordinate representation (object space) to an alternatively based coordinate system such as world space or normalized device coordinates (NDC) space. The vertex shader unit 225 may read vertex attribute data directly from the GPU local memory 160. The vertex shader unit 225 may read texture map data as well as uniform data that is stored in GPU local memory 160 through an interface (not shown) for use in processing the vertex data. The vertex shader 225 represents the vertex processing domain of the graphics processing subsystem 150.

A primitive assembler unit 230 is fixed-function unit that receives transformed vertex data from vertex shader unit 225 and constructs graphics primitives, e.g., points, lines, triangles, or the like, for processing by the geometry shader unit 235 or the rasterizer unit 240. The constructed graphics primitives may include a series of one or more vertices, each of which may be shared amongst multiple primitives, and state information, such as a primitive identifier, defining the primitive. In alternative examples, a second primitive assembler (not shown) may be included subsequent to the geometry shader 235 in the data flow through the graphics pipeline 200. Each primitive may include a series of one or more vertices and primitive state information defining the primitive. A given vertex may be shared by one or more of the primitives constructed by the primitive assembly unit 230 throughout the graphics pipeline 200. For example, a given vertex may be shared by three triangles in a triangle strip without replicating any of the data, such as a normal vector, included in the given vertex.

The geometry shader unit 235 receives the constructed graphics primitives from the primitive assembler unit 230 and performs fixed-function viewport operations such as clipping, projection and related transformations on the incoming transformed vertex data. In the graphics processing subsystem 150, the geometry shader unit 235 is a programmable execution unit that is configured to execute machine code geometry shader program to process graphics primitives received from the primitive assembler unit 230 as specified by the geometry shader program. For example, the geometry shader unit 235 may be further programmed to subdivide the graphics primitives into one or more new graphics primitives and calculate parameters, such as plane equation coefficients, that are used to rasterize the new graphics primitives. The geometry shader unit 235 may read data directly from the GPU local memory 160. Further, the geometry shader unit 235 may read texture map data that is stored in GPU local memory 160 through an interface (not shown) for use in processing the geometry data. The geometry shader unit 235 represents the geometry processing domain of the graphics processing subsystem 150. The geometry shader unit 235 outputs the parameters and new graphics primitives to a rasterizer unit 240. It should be noted that the geometry shader unit 235 is an optional unit of the graphics pipeline. The data processing of the geometry shader unit 235 may be omitted.

The rasterizer unit 240 receives parameters and graphics primitives from the primitive assembler unit 230 or the geometry shader unit 235. The rasterizer unit 240 is a fixed-function unit that scan-converts the graphics primitives and outputs fragments and coverage data to the fragment shader unit 245.

The fragment shader unit 245 is a programmable execution unit that is configured to execute machine code fragment shader programs to transform fragments received from rasterizer unit 245 as specified by the machine code fragment shader program. For example, the fragment shader unit 245 may be programmed to perform operations such as perspective correction, texture mapping, shading, blending, and the like, to produce shaded fragments that are output to a raster operations unit 250. The fragment shader unit 245 may read data directly from the GPU local memory 160. Further, the fragment shader unit 245 may read texture map data as well as uniform data that is stored in GPU local memory 160, such as the texture buffer 162-2, through an interface (not shown) for use in processing the fragment data.

The raster operations unit 250 or per-fragment operations unit optionally performs fixed-function computations such as near and far plane clipping and raster operations, such as stencil, z test and the like, and outputs pixel data as processed graphics data for storage in a buffer in the GPU local memory 160, such as the frame buffer 161.

A vertex refers to a data structure, which describes position of a point in 2D or 3D space and further attributes associated therewith. A set of vertices defines the location of corners of one or more surfaces constructed of basic graphical elements, which are also denoted as primitives, and other attributes of the surfaces. Each object to be displayed is typically approximated as a polyhedral. A polyhedral a solid in three dimensions with flat faces, straight edges and sharp corners or vertices. The flat faces are joined at their edges. The flat faces are modeled as primitives, the corners of which are defined by a respective set of vertices. The set of vertices define inter alia the location and orientation of the primitive in space. The attributes of a vertex may include a color value at the vertex point, a reflectance value of the surface at the vertex, one or more textures stored in one or more texture buffers and texture coordinates of the surface at the vertex, and the normal of an approximated curved surface at the location of the vertex. The vertex data is provided as an ordered list of vertices, a vertex stream, to the graphics pipeline described herein. The interpretation of the stream of vertices associates each vertex with one or more primitives out of a list of predefined primitives supported by the graphics processing pipeline, such as e.g. point primitives, line primitives, polygon primitives, triangle primitives, quad primitives and variants thereof.

As described above, the fragment shader unit 245 is inter alia arranged to map texture data to produce shaded fragments. Texture data is provided in one or more texture buffers 162-2, which are in particular read-only buffers and which store image data that is used for putting images onto primitives such as triangles in a process called texture mapping.

The texture data stored in a texture buffer 162-2 is two-dimensional data but can be one- or three-dimensional as well. At each pixel of the image in the frame buffer to be displayed the corresponding value has to be found in or determined from the texture data or texture map.

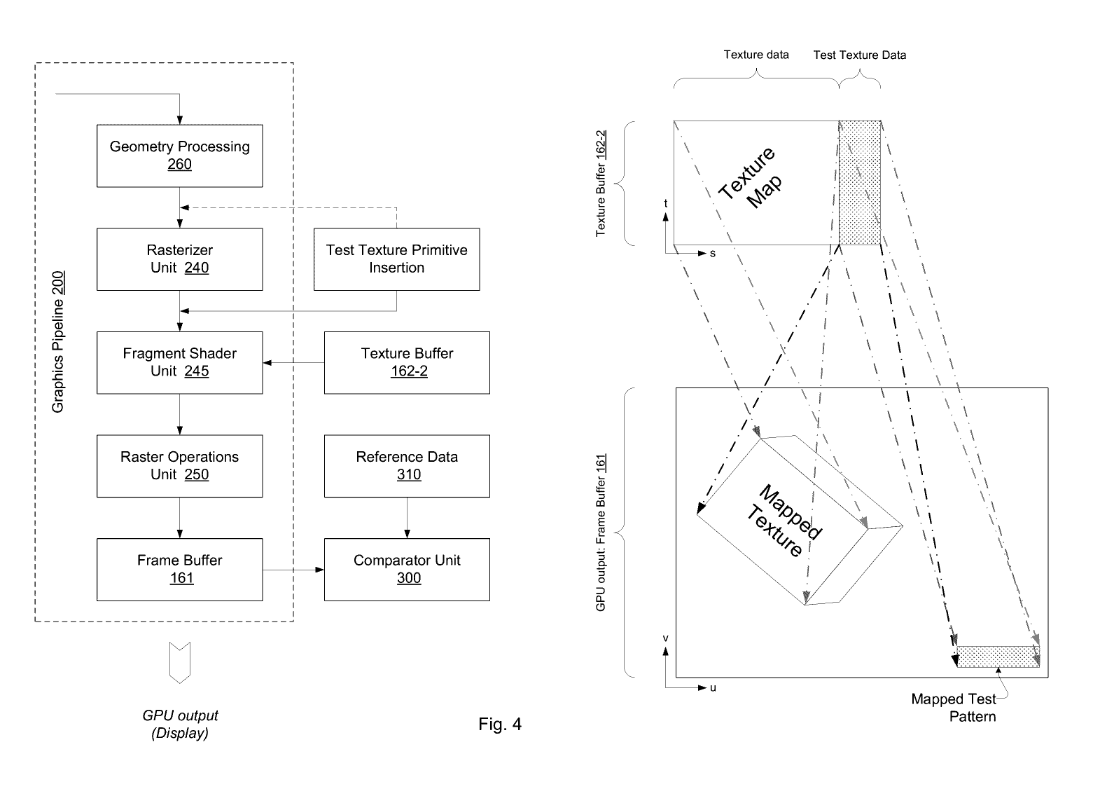

The individual elements in the texture data are called texels (a compound term from texture elements) to differentiate them from pixels in the frame buffer. Each vertex of a primitive comprises an attribute defining a so-called texture coordinate (u, v), which is a 2D position on the texture map. As illustratively shown in FIG. 4, the coordinate (u, v) of an image pixel of a quad primitive is used to look up a corresponding texel in the texture map, which extends in (s, t) coordinates. The texture map texels are defined in a normalized frame of reference (s, t), which ranges from 0 to 1 along the s axis and t axis. The u and v coordinates typically range from 0 up to the texture's width and height, but may also go beyond to allow effects such as texture wrapping. The texture coordinates may be determined by interpolating values at each vertex, and then the coordinates are used to look up the color, which is applied to the current pixel. Looking up a single color may be for instance based on interpolation algorithms such as nearest filtering and bilinear filtering.

Texture data may be provided in a plurality of texture buffers, each comprises different texture maps to be mapped on one or more different surfaces of primitives to generate the image in the frame buffer 161. In order to verify the origin texture buffer, from which texture data is read, the texture buffer comprises the texture data to be mapped and a test texture data. The test texture data is mapped at a predefined area within the frame buffer comprising the image to be displayed as shown in FIG. 4. Accordingly, at least one of the width and height of the texture data differs from the texture buffer's width and height, respectively.

Referring now to the excerpt view of the graphics processing pipeline 200 additionally shown in FIG. 4, the verification functionality according to an example of the present application will be further described.

As already summarized above within the graphics processing pipeline 200, geometry processing section 260 comprising the vertex shader unit, primitive assembler 230 and geometry shader 235 and a fragment processing section comprising the fragment shader unit 245 perform a variety of computational functions. Some of these functions are table lookup, scalar and vector addition, multiplication, division, coordinate-system mapping, calculation of vector normals, calculation of derivatives, interpolation, filtering, and the like. Geometry processing section 260 and fragment processing are optionally configured such that data processing operations are performed in multiple passes through graphics processing section 260 or in multiple passes through fragment processing section. Each pass through programmable graphics processing section 260 or fragment processing section may conclude with optional processing by a raster operations unit 250.

Geometry processing section 260 receives a stream of program instructions (vertex program instructions and geometry shader program instructions) and data and performs vector floating-point operations or other processing operations using the data.

Data processed by geometry processing section 260 and program instructions are passed to the rasterizer unit 240. The rasterizer unit 240 is a sampling unit that processes primitives and generates sub-primitive data, such as fragment data, including parameters associated with fragments (texture identifiers, texture coordinates, and the like). The rasterizer unit 240 converts the primitives into sub-primitive data by performing scan conversion on the data processed by geometry processing section 260. The rasterizer unit 240 outputs fragment data to fragment shader unit 245. The fragment data may include a coverage mask for each pixel group that indicates which pixels are covered by the fragment.

The fragment shader unit 245 of the graphics pipeline 200 is configured to perform texture mapping to apply a texture map to the surface of a primitive. A texture map is stored in the texture buffer 162-2. To allows for texture mapping, the vertices of the primitive may be associated with (u, v) coordinates in the texture map, and each pixel of the surface defined by the primitive is then associated with specific texture coordinates in the texture map. Texturing is achieved by modifying the color of each pixel of the surface defined by the primitive with the color of the texture map at the location indicated by that pixel's texture coordinates. The texturing of the surface of the primitive is specified by the machine code fragment shader program executed by the fragment shader unit 245.

The raster operations unit 250 optionally performs near and far plane clipping and raster operations using the fragment data and pixel data stored in the frame buffer 161 at a pixel position (data array entry specified by (x, y)-coordinates) associated with processed fragment data. The output data from raster operations unit 250 is written back to the frame buffer 161 at the pixel position associated with the output data.

In an example of the present application, the texture mapping performed by the fragment shader unit 245 is further used to map the test texture data to the predefined area within the frame buffer 161. The test texture data may comprises one or more texels. In particular, the test texture data may comprise one or more lines or one or more columns of texels in the texture buffer. A line of texels comprises a number of texels corresponding to the width of the texture buffer and a column of texels comprises a number of texels corresponding to the height of the texture buffer.

In an example of the present application, a test texture graphics primitive and/or fragment and coverage data thereof is inserted into the data flow of the graphics pipeline 200 upstream to the fragment shader unit 245. The test texture graphics primitive and/or fragment and coverage data thereof may be precomputed based on the size and location of the test texture data in the texture buffer 162-2 and the area in the frame buffer 161, on which the test texture data is mapped.

Fragment shader 132 may be further configured to perform texture filtering and/or other graphics operations.

A comparator unit 300 is further provided, which is coupled to the frame buffer 161 and which is arranged to verify the mapped test texture in the predefined area of the frame buffer. The comparator unit 300 having access to the frame buffer 300 may for instance extract the pixels within the predefined area and compares the extracted pixel data with reference data 310. The predefined area comprises the mapped test texture data. The reference data may for instance comprise precomputed mapped test texture data provided to the comparator 300 for comparing with image data obtained or extracted from the predefined area of the image data stored in the frame buffer 161.

In an example of the present application, the comparator 300 is configured to determine a checksum based on the pixel values (pixel color values) in the predefined area eventually in conjunction with the respective locations thereof. The checksum may be for instance determined in accordance with a cyclic redundancy check (CRC) algorithm, checksum algorithm a cryptographic hash function algorithm or a non-cryptographic hash function algorithm. Such a checksum is precomputed for respective test texture data and the mapping operation applied thereto and provided in form of reference data 310 to the comparator unit 300.

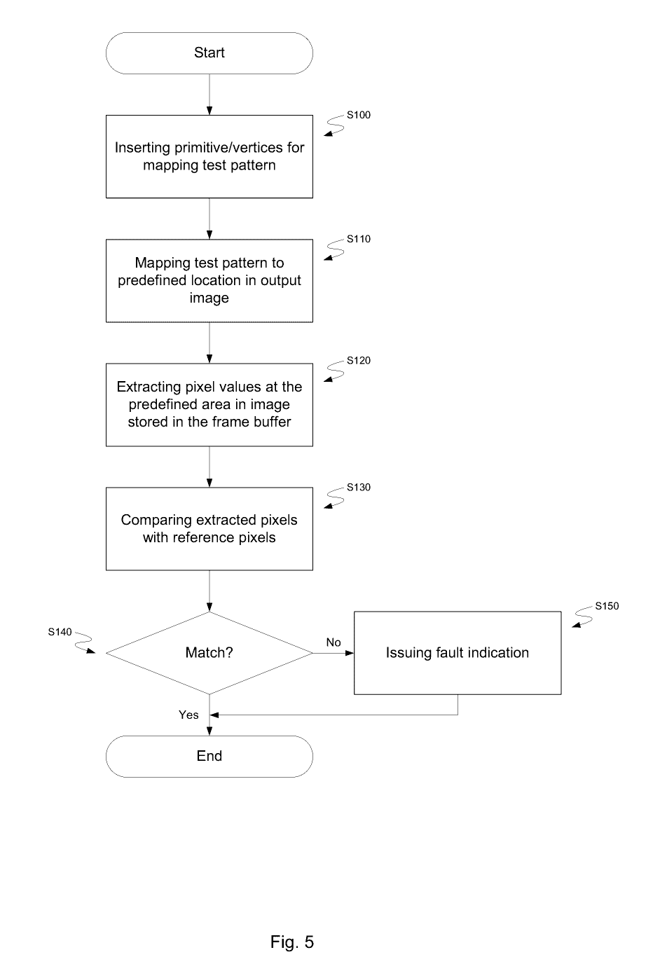

Referring now to FIG. 5, a flow diagram of a method of verifying the origin texture buffer in graphics pipeline processing according to an example of the present application is illustratively depicted.

In an operation S100, data relating to mapping of a test texture pattern stored at one or more predefined locations in a predefined texture buffer 162-2 is inserted into the graphics processing pipeline 200. The data relating to mapping of a test texture pattern is provided to instruct the fragment shader unit 245 of the graphics processing pipeline 200 to map the test texture data at the predefined locations in the predefined texture buffer 162-2 to a predefined area of the image in the frame buffer 161.

The data relating to mapping of a test texture data may be inserted into the graphics processing pipeline 200 in form of a set of vertices and uniform data defining a test texture primitive. The test texture primitive and the vertices thereof are defined to be located in the predefined area of the image in the frame buffer 161. The texture coordinates refer to the test texture data in the predefined texture buffer for mapping the test texture data accordingly on the surface of the test texture primitive.

The data relating to the mapping of the text texture data may be inserted into the graphics processing pipeline 200 in form of fragment and coverage data relating to the test texture primitive. The fragment and coverage data comprises one or more fragments for each pixel covering the test texture primitive. The one or more fragments comprises interpolated values, which are used to map the fragments with the test texture data.

Based on the data relating to mapping of a test texture data, the fragment shader unit 245 maps the test texture data to the predefined area in the image stored in the frame buffer 161 in an operation S110.

In an operation S120, the pixel values of the image data stored in the frame buffer 161 at the predefined area are extracted by the comparator unit 300. The extracted pixel values are compared by the comparator unit 300 with reference data provided thereto in an operation S130 in order to determine whether the extracted pixel values match with reference data in an operation S140. In case the extracted pixel values do not match with the reference data a fault indication signal or message is generated and issued in an operation S150 to indicate that the expected data is not present in the predefined area of the image data stored at the frame buffer 161. As aforementioned, the comparison executed by the comparator unit 300 may be performed on the basis of checksum and/or hash values determined on the basis of the extracted pixel values eventually in conjunction with the respective locations thereof. The extracted pixel values may comprise pixel color values. The pixel location may comprise a pixel coordinate e.g. with respect to a frame of reference ranging up to the frame buffer's width and height.

Those skilled in the art will appreciate that the dimension of the frame buffer 161 and the image stored thereat may exceed the dimension of the displayed image, which is a part of the image stored in the frame buffer 161. The predefined area, to which the test texture data is mapped, may be located in a region not part of the displayed image. Hence, the mapped test texture data is not visible to a user on a display showing the image generated by the graphics processing pipeline 200.

It should be further noted that the image generated by the fragment shader unit 245 in the frame buffer 161 may be further processed. As illustrated with reference to FIG. 3, a raster operations unit 250 or per-fragment operations unit may optionally perform fixed-function computations and raster operations on the image data stored in the frame buffer 161. The reference data provided for comparison with the pixel values extracted by the comparator unit 300 have to be precomputed considering image manipulation of the raster operations unit 250 or per-fragment operations unit, which has effect to the mapped test texture data. The image manipulation of the raster operations unit 250 or per-fragment operations unit are predetermined and hence can be considered for precomputing the reference data.

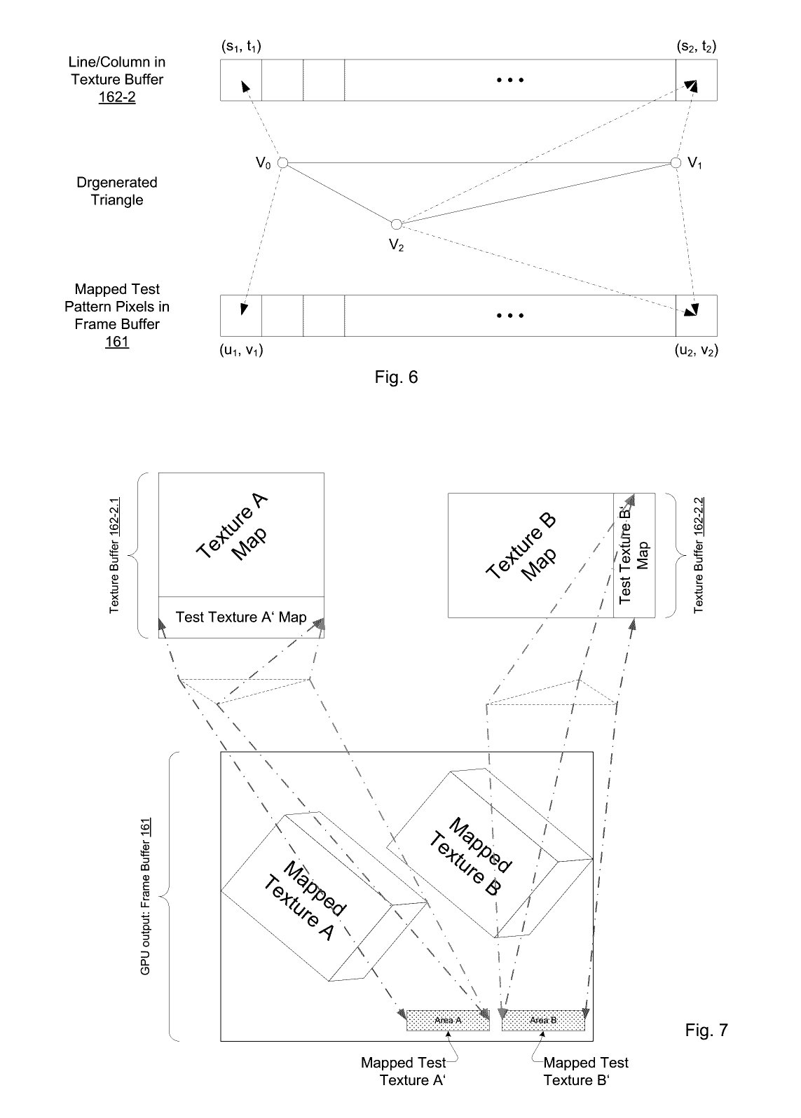

Referring now to FIG. 6, a schematic illustration is shown exemplifying a degenerated triangle primitive as test texture primitive to map the test texture data to the predefined area in the image stored at the frame buffer 161.

The test texture data comprises one or more texels. In particular, the test texture data comprises a number of texels equal to line or column in the texture buffer 162-2 (e.g. number of texels equal to the texture buffer's width and height, respectively).

The degenerated triangle primitive is defined on the basis of three vertices V₀ to V₂. One or the vertex is defined by a first image coordinate (u₁, v₁) and the other two of the vertices are defined by a second image coordinate (u₂, v₂). Each vertex of the degenerated triangle primitive has associated a texture coordinate. One vertex V₀ has associated a first texture coordinate (s₁, t₁) and the other two vertices V₁ and V₂ have associated a second texture coordinates (s₂, t₂).

As a result, the degenerated triangle primitive is defined to map the sequence of texels extending from the first texture coordinate (s₁, t₁) up to the second texture coordinates (s₂, t₂) to a one pixel width linear area of pixels extending from the first image coordinate (u₁, v₁) up to the second image coordinate (u₂, v₂).

Referring now to FIG. 7, schematically illustrates the use of several frame buffers to provide texture data for an image generated by the fragment shader unit 245.

The fragment shader unit 245 may have access to several texture buffers 162-2.1 and 162-2.2, each storing separate texture data for being mapped on one or more primitive surfaces. The texture buffers 162-2.1 and 162-2.2 may be logical partitions of a texture memory. The texture buffers 162-2.1 and 162-2.2 may individually and separately addressable memory areas within a common texture memory. One or more texture buffers store test texture data in addition to the texture data.

The test texture data may be specific for each texture buffer 162-2.1 and 162-2.2. The test texture data may be specific for texture data, together with which it is stored in a texture buffer 162-2.1, 162-2.2. For instance, the mapped test texture data may allow to identify the texture buffer from which it originates. The mapped test texture data may allow to identify the texture data together with which it has been stored in a texture buffer. The test texture data may differ in size and/or texel values from each other. The test texture data may differ in the locations at which it is stored in the texture buffer. E.g. the test texture A′ data comprises one or more lines of the texture buffer 162-2.1 and the test texture B′ data comprises one or more columns of the texture buffer 162-2.2.

The test texture data may be mapped to a predefined area specific for the texture buffer 162-2.1, 162-2.2. For instance the test texture A′ data is mapped to the predefined area A in the image stored at the frame buffer 161 and the test texture B′ data is mapped to the predefined area B in the image stored at the frame buffer 161. The predefined areas are distinct from each other. The predefined areas may differ in size and/or location from each other.

A test texture primitive may be inserted into the graphics processing pipeline 200 for each test texture to be mapped into the image stored at the frame buffer 161.

According to an example of the present application, an apparatus for verifying the origin of texture data is provided, which comprises a frame buffer 161; at least one texture buffer 162-2; a graphics processing pipeline 200 with a fragment shader unit 245; and a comparator unit 300. The frame buffer 161 is provided to buffer image data to be displayed. The at least one texture buffer 162-2 is provided to store texture data and test texture data. The fragment shader unit 245 is coupled to the frame buffer 161 and the at least one texture buffer 162-2. The fragment shader unit 245 is further configured to map the test texture data retrieved from the texture buffer 162-2 on a predefined area of the image data stored in the frame buffer 161. The comparator unit 300 is coupled to the frame buffer 161. The comparator unit 300 is further configured to extract image data values located in the predefined area of the image data stored in the frame buffer 161; to compare the extracted image data with reference data and to issue a fault indication signal in case the extracted image data and the reference data mismatch with each other, e.g. in case the extracted image data and the reference data do not comply with each other.

According to an example of the present application, the comparator unit 300 is further configured to determine a checksum based on the extracted image data values and compare the checksum with the reference data comprising a reference checksum.

According to an example of the present application, the reference data is precomputed on the basis of the test texture data and a test texture primitive, on which surface the test texture data is mapped.

According to an example of the present application, the fragment shader unit 245 is configured to receive a stream of fragment data generated by a rasterizer unit 240 arranged upstream to the fragment shader unit 245 in the graphics processing pipeline 200.

According to an example of the present application, the fragment shader unit 245 is configured to map the test texture data on the predefined area in accordance with a test texture primitive inserted into the data flow of the graphics processing pipeline 200.

According to an example of the present application, the test texture primitive is a degenerated triangle primitive. The texture coordinates associated with the degenerated triangle primitive refer to a sequence of neighboring texels forming the test texture data.

According to an example of the present application, the test texture primitive is inserted into the data flow of the graphics processing pipeline 200 in form of predetermined fragment data to be processed by the fragment shader unit 245.

According to an example of the present application, a method for verifying the origin of texture data is provided, which comprises providing at least one texture buffer 162-2 with texture data and test texture data; mapping the test texture data retrieved from the texture buffer 162-2 on a predefined area of the image data stored in a frame buffer 161 using a fragment shader unit 245 of a graphics processing pipeline 200; extracting, by a comparator unit 300, image data values located in the predefined area of the image data stored in the frame buffer 161; comparing, by the comparator unit 300, the extracted image data with reference data; and issuing, by the comparator unit 300, a fault indication signal in case the extracted image data and the reference data mismatch with each other.

According to an example of the present application, the method further comprises determining, by the comparator unit 300, a checksum based on the extracted image data values; and comparing, by the comparator unit 300, the checksum with the reference data comprising a reference checksum.

According to an example of the present application, the reference data is precomputed on the basis of the test texture data and a test texture primitive, on which surface the test texture data is mapped.

According to an example of the present application, the method further comprises receiving a stream of fragment data generated by a rasterizer unit 240 arranged upstream to the fragment shader unit 245 in the graphics processing pipeline 200.

According to an example of the present application, the method further comprises inserting a test texture primitive inserted into the data flow of the graphics processing pipeline 200; and mapping the test texture data on the predefined area in accordance with the inserted test texture primitive using the fragment shader unit 245 of the graphics processing pipeline 200.

According to an example of the present application, the method further comprises inserting the test texture primitive into the data flow of the graphics processing pipeline 200 in form of predetermined fragment data to be processed by the fragment shader unit 245.

According to an example of the present application, a non-transitory, tangible computer readable storage medium is provided bearing computer executable instructions for verifying the origin of texture data, wherein the instructions, when executing on one or more processing devices, cause the one or more processing devices to perform a method comprising: mapping a test texture data retrieved from at least one texture buffer 162-2 on a predefined area of the image data stored in a frame buffer 161 using a fragment shader unit 245 of a graphics processing pipeline 200; extracting image data values located in the predefined area of the image data stored in the frame buffer 161; comparing the extracted image data with reference data; and issuing a fault indication signal in case the extracted image data and the reference data mismatch. The at least one texture buffer 162-2 is provided with a texture data and the test texture data.

Descriptions made above with reference to FIG. 1 through FIG. 7 may be applied to the present embodiment as is and thus, further detailed descriptions will be omitted here.

The processing method and apparatus according to the above-described examples may use one or more processors, which may include a microprocessor, central processing unit (CPU), digital signal processor (DSP), or application-specific integrated circuit (ASIC), as well as portions or combinations of these and other processing devices.

The examples described herein refer to flowchart illustrations of the apparatus and method for graphics processing using a comparator unit. It will be understood that each block of the flowchart illustrations, and combinations of blocks in the flowchart illustrations, can be implemented by computer program instructions. These computer program instructions can be provided to one or more processors of a general purpose computer, special purpose computer, or other programmable data processing apparatus to produce a machine, such that the instructions, which execute via the one or more processors of the computer or other programmable data processing apparatus, may implement the functions specified in the flowchart block or blocks.

Each block of the flowchart illustrations may represent a unit, module, segment, or portion of code, which comprises one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

The terms “module”, and “unit,” as used herein, may refer to, but is not limited to, a software or hardware component, such as a Field Programmable Gate Array (FPGA) or Application Specific Integrated Circuit (ASIC), which performs certain tasks. A module or unit may be configured to reside on an addressable storage medium and configured to execute on one or more processors. Thus, a module or unit may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules/units may be combined into fewer components and modules/units or further separated into additional components and modules.

Those of skill in the art would further understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the disclosure herein may be implemented as electronic hardware, computer software, or combinations of both. To illustrate clearly this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The processing method according to the above-described examples may be recorded in tangible non-transitory computer-readable media including program instructions to implement various operations embodied by a computer. The media may also include, alone or in combination with the program instructions, data files, data structures, and the like. Examples of tangible, non-transitory computer-readable media include magnetic media such as hard disks, floppy disks, and magnetic tape; optical media such as CD ROM disks and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments, or vice versa.

An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Those skilled in the art will recognize that the boundaries between the illustrated logic blocks and/or functional elements are merely illustrative and that alternative embodiments may merge blocks or elements or impose an alternate decomposition of functionality upon various blocks or elements. Thus, it is to be understood that the architectures depicted herein are merely exemplary, and that in fact many other architectures can be implemented which achieve the same functionality.

Any arrangement of components to achieve the same functionality is effectively associated such that the desired functionality is achieved. Hence, any two components herein combined to achieve a particular functionality can be seen as associated with each other such that the desired functionality is achieved, irrespective of architectures or intermedial components. Likewise, any two components so associated can also be viewed as being operably connected, or operably coupled, to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, the examples, or portions thereof, may implemented as soft or code representations of physical circuitry or of logical representations convertible into physical circuitry, such as in a hardware description language of any appropriate type.

Also, the invention is not limited to physical devices or units implemented in non-programmable hardware but can also be applied in programmable devices or units able to perform the desired device functions by operating in accordance with suitable program code, such as mainframes, minicomputers, servers, workstations, personal computers, notepads, personal digital assistants, electronic games, automotive and other embedded systems, cell phones and various other wireless devices, commonly denoted in this application as “computer systems”.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an”, as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an”. The same holds true for the use of definite articles. Unless stated otherwise, terms such as “first” and “second” are used to distinguish arbitrarily between the elements such terms describe. Thus, these terms are not necessarily intended to indicate temporal or other prioritization of such elements. The mere fact that certain measures are recited in mutually different claims does not indicate that a combination of these measures cannot be used to advantage.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

1. An apparatus for verifying the origin of texture data, said apparatus comprising:
a frame buffer provided to buffer image data to be displayed;
at least one texture buffer provided to store texture data and test texture data;
a graphics processing pipeline comprising a fragment shader unit,
wherein the fragment shader unit is coupled to the frame buffer and the at least one texture buffer,
wherein the fragment shader unit is configured to map the test texture data retrieved from the texture buffer on a predefined area of the image data stored in the frame buffer; and
a comparator unit coupled to the frame buffer,
wherein the comparator unit is configured
to extract image data values located in the predefined area of the image data stored in the frame buffer,
to compare the extracted image data with reference data and
to issue a fault indication signal in case the extracted image data and the reference data mismatch with each other.

2. The apparatus according to claim 1,
wherein the comparator unit is further configured to determine a checksum based on the extracted image data values and compare the checksum with the reference data comprising a reference checksum.

3. The apparatus according to claim 1,
wherein the reference data is precomputed on the basis of the test texture data and a test texture primitive, on which surface the test texture data is mapped.

4. The apparatus according to claim 1,
wherein the fragment shader unit is configured to receive a stream of fragment data generated by a rasterizer unit arranged upstream to the fragment shader unit in the graphics processing pipeline.

5. The apparatus according to claim 1,
wherein the fragment shader unit is configured to map the test texture data on the predefined area in accordance with a test texture primitive inserted into the data flow of the graphics processing pipeline.

6. The apparatus according to claim 5,
wherein the test texture primitive is a degenerated triangle primitive, wherein the texture coordinates associated with the degenerated triangle primitive refer to a sequence of neighboring texels forming the test texture data.

7. The apparatus according to claim 5,
wherein the test texture primitive is inserted into the data flow of the graphics processing pipeline in form of predetermined fragment data to be processed by the fragment shader unit.

8. A method for verifying the origin of texture data, said method comprising:
providing at least one texture buffer with texture data and test texture data;
mapping the test texture data retrieved from the texture buffer on a predefined area of the image data stored in a frame buffer using a fragment shader unit of a graphics processing pipeline;
extracting image data values located in the predefined area of the image data stored in the frame buffer;
comparing the extracted image data with reference data; and
issuing a fault indication signal in case the extracted image data and the reference data mismatch.

9. The method according to claim 8, further comprising:
determining a checksum based on the extracted image data values; and
comparing the checksum with the reference data comprising a reference checksum.

10. The method according to claim 8,
wherein the reference data is precomputed on the basis of the test texture data and a test texture primitive, on which surface the test texture data is mapped.

11. The method according to claim 8, further comprising:
receiving a stream of fragment data generated by a rasterizer unit arranged upstream to the fragment shader unit in the graphics processing pipeline.

12. The method according to claim 8, further comprising:
inserting a test texture primitive inserted into the data flow of the graphics processing pipeline; and
mapping the test texture data on the predefined area in accordance with the inserted test texture primitive using the fragment shader unit of the graphics processing pipeline.

13. The method according to claim 12, further comprising:
inserting the test texture primitive into the data flow of the graphics processing pipeline in form of predetermined fragment data to be processed by the fragment shader unit.

14. A non-transitory, tangible computer readable storage medium bearing computer executable instructions for verifying the origin of texture data, wherein the instructions, when executing on one or more processing devices, cause the one or more processing devices to perform a method comprising:
mapping the test texture data retrieved from the at least one texture buffer on a predefined area of the image data stored in a frame buffer using a fragment shader unit of a graphics processing pipeline, wherein the at least one texture buffer is provided with a texture data and the test texture data;
extracting image data values located in the predefined area of the image data stored in the frame buffer;
comparing the extracted image data with reference data; and
issuing a fault indication signal in case the extracted image data and the reference data mismatch.
